(19) United States
(12) Patent Application Publication
(10) Pub. No.: US 2004/0146678 A1
(43) Pub. Date: Jul. 29, 2004

(54) Insulating system for pipes and pipe bends

(76) Inventor: John Kroon, Calgary (CA)

Correspondence Address: STURM & FIX LLP, 206 SIXTH AVENUE, SUITE 1213, DES MOINES, IA, 50309-4076, US

(21) Appl. No.: 10/353,301

(22) Filed: Jan. 29, 2003

(51) Int. Cl. B32B 1/08

(52) U.S. Cl. 428/36.91; 156/188; 156/191

(57) ABSTRACT

An insulating system (10) for protecting the exterior surfaces of steel pipes and pipe bends (100) from corrosive elements wherein, the insulating system (10) includes a primary coating (20) on the exterior surface of the steel pipe (100) a first inner layer of tape wrap (30) a pair of polyurethane half shells (40) (40′) surrounding the first layer of tape wrap (30) wherein, the exterior surfaces of the polyurethane half shells (40) (40′) are provided with a coating of mastic (50) that bonds with a second outer layer of tape wrap (60).

### CROSS REFERENCE TO RELATED APPLICATIONS

Not applicable.

### BACKGROUND OF THE INVENTION

1. Field of the Invention

The present invention relates to the field of pipe insulation in general and in particular for pipe insulation for use in highly corrosive environments such as in the petrochemical industry.

2. Description of Related Art

As can be seen by reference to the following U.S. Pat. Nos. 6,058,979; 4,606,953; 4,946,528; 5,178,902; and, 5,534,319, the prior art is replete with myriad and diverse pipe insulating systems employed in a variety of different environments.

While all of the aforementioned prior art constructions are more than adequate for the basic purpose and function for which they have been specifically designed, they are uniformly deficient with respect to their failure to provide a simple, efficient, and practical multi-layer precision fit pipe insulating system for use in highly corrosive environments such as the petrochemical industry.

One of the major causes of corrosion developing on pipe surfaces in the oil and gas industry has been determined to be based at least in part on the improperly manufactured and/or fitted insulating half shells which allow condensation and/or other corrosive liquids to collect on the exterior surfaces of the pipes upon which the exterior surfaces of the pipes are installed.

As a consequence of the foregoing situation, there has existed a longstanding need in the oil and gas industries for a new and improved multi-layer insulation system for steel pipes in general and steel pipe bends in particular, and the provision of such a system is the stated objective of the present invention.

### BRIEF SUMMARY OF THE INVENTION

Briefly stated, the multi-layer insulation system for steel pipes that forms the basis of the present invention comprises in general an inner layer or coating, a pair of intermediate polyurethane half shells, and an outer mechanical barrier all of which cooperate with one another to form an effective barrier against both concentrations of and migrations by corrosive elements along steel pipes and pipe bends in the oil and gas industry.

As will be explained in greater detail further on in the specification, the inner layer may comprise a spray coating of epoxy, polyurethane or FBE applied to the exterior surface of the bend in a steel pipe inasmuch as that appears to be one of the highest areas of concentration for corrosion and/or a tape wrapping along a running length of pipe to form an initial mechanical barrier.

The intermediate layer includes a pair of polyurethane half shells having generally C-shaped cross-sectional configurations that are precision cut to exact thicknesses, wherein one of the half shells is provided with a pair of elongated longitudinal grooves formed on the ends of the opposite arms of the generally C-shaped configuration and, the other of the half shells is provided with a pair of complementary longitudinal projections on the ends of the opposite arms of the generally C-shaped configuration, wherein the grooves and projections matingly engage one another in a dovetail fashion to operatively connect the polyurethane half shells together.

In addition, the outer and final layer comprises a mechanical tape wrap barrier that overlies a mastic coating to form ship lap ends, wherein the mastic coating further chemically bonds the opposed faces of the polyurethane half shells together to form a tight seal and prevent the migration of corrosive elements along the exterior surface of the steel pipe and pipe bends.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings, wherein:

FIG. 1 is an exploded perspective view of the components and layers that form the basis of this invention in relation to a section of steel pipe;

FIG. 2 is a cross-sectional view taken through line 2-2 of FIG. 1; and,

FIG. 3 is an enlarged exploded detail view of the various layers and components that comprise this invention.

### DETAILED DESCRIPTION OF THE INVENTION

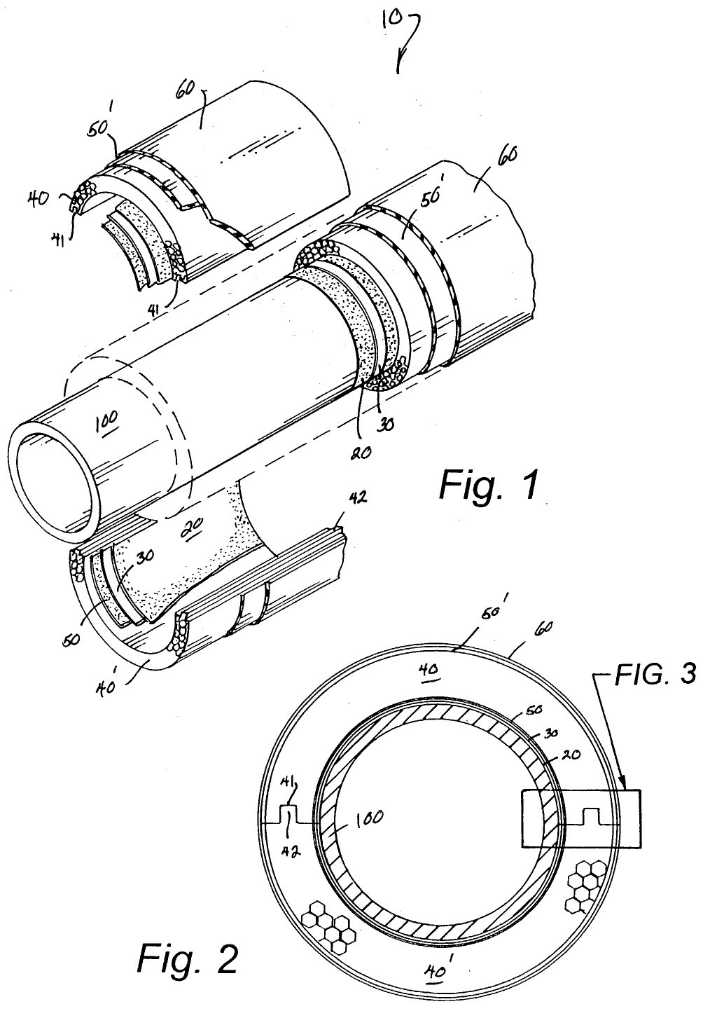

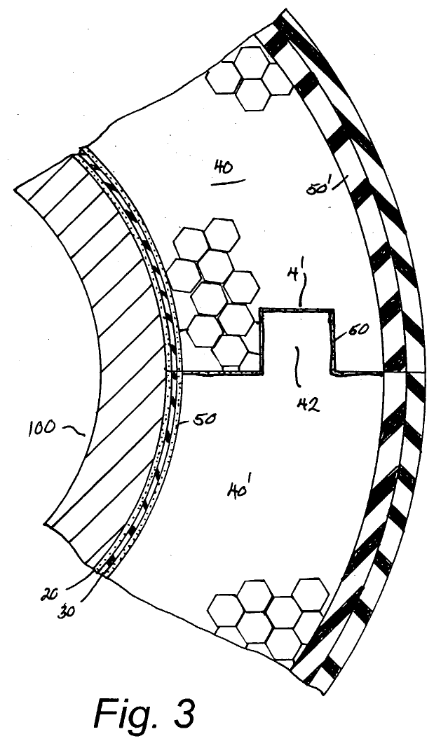

As can be seen by reference to the drawings, and in particular to FIG. 1, the insulating system for steel pipes that forms the basis of the present invention is designated generally by the reference number 10. The system 10 comprises a primer coating 20, a first layer of tape wrap 30, a pair of polyurethane half shells 40 joined together both mechanically and chemically bonded together by a layer of mastic 50 which is also applied to the exterior surface of the polyurethane half shells 40 wherein, the exterior portion of the mastic layer 50 also adheres to an outer layer of tape wrap 60. These components and layers will now be described in seriatim fashion.

As shown in FIGS. 1 and 2, the primer coating 20 is sprayed on the running length of steel pipe and comprises a generally uniform thickness ranging from 1-2 mils of either epoxy, polyurethane, or FBE. The inner tape layer 30 is wrapped around the primer coating 20 in a 25% to 50% overlapping fashion to a thickness of between 13 to 14 mils wherein, the primer coating 20 and the tape layer 30 form the initial corrosion barrier of the pipe insulating system 10.

In addition, the pair of polyurethane half shells 40 40′ each has a generally C-shaped cross-sectional configuration and is fabricated from 3# minimum 90% to 95% closed cell polyurethane foam the normal uniform thickness of which ranges between 1 to 3 inches. Furthermore, the half shells 40 40′ are spray- or injected-molded and then precisely contoured to exact specifications by computer guided cutting machines.

As can also be seen by reference to FIGS. 1 and 2, one of the polyurethane half shells 40 is provided with a pair of longitudinal contoured grooves 41 41 wherein, each groove 41 is formed on the terminal ends of the C-shaped configuration, and the other of the polyurethane half shells 40′ is provided with a pair of raised longitudinal projections 42 42 formed on the terminal ends of the C-shaped configuration wherein, the configuration of the grooves 41 41 and the projections 42 42 are complementary with one another, so as to be mechanically joined to one another in a mating dovetail fashion.

At this juncture, it should be noted that prior to the mechanical joining of the half shells 40 40′, their abutting faces are first provided with a layer of mastic 50 to allow for the mechanical joining and chemical sealing of the juncture between the half shells 40 40′. Then once the half shells 40 40′ have been sealingly engaged with one another, an additional uniform layer of mastic 50′ is applied to the external periphery of the joined half shells 40 40′ in anticipation of the final step in the application of the insulating system 10 to the exterior of a steel pipe 100 and/or pipe bend.

This final step involves the application of an outer layer of tape wrap 20 employing a 25% to 50% wrap overlap to an approximate thickness of 35 mil to form the final mechanical barrier to the invasive effects of corrosive elements on the exterior surfaces of steel pipes and/or pipe bends 100.

The outer layer of tape wrap 60 also includes shop lap fitted ends and as shown in FIG. 2, at least one of the half shells 40′ may be provided with a discrete longitudinal bore 70 which forms a heat trace conduit or the like.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

Having thereby described the subject matter of the present invention, it should be apparent that many substitutions, modifications, and variations of the invention are possible in light of the above teachings. It is therefore to be understood that the invention as taught and described herein is only to be limited to the extent of the breadth and scope of the appended claims.

I claim:

1. An insulating system to provide a protective barrier on steel pipes and/or pipe bends against corrosive elements encountered in the oil and gas industry wherein, the insulating system comprises
an inner layer of tape wrap disposed in an enveloping relationship with the exterior surface of the steel pipe
a pair of elongated polyurethane half shells having generally C-shaped cross-sectional configurations, wherein the terminal ends of the C-shaped configurations are operatively connected together to surround the steel pipe and the inner layer of tape wrap; and,
an outer layer of tape wrap disposed in a surrounding relationship relative to the joined half shells.

2. The insulating system as in claim 1; further comprising
a primer coating disposed intermediate said inner layer of tape wrap and the exterior surface of said steel pipe.

3. The insulating system as in claim 2; wherein, said primer coating is selected from among one of the following: epoxy, polyurethane, FBE.

4. The insulating system as in claim 2; wherein, the primer coating has a uniform thickness in the range of approximately 1-2 mils.

5. The insulating system as in claim 1; wherein, said inner layer of tape wrap is thinner than said outer layer of tape wrap.

6. The insulating system as in claim 5; wherein, the outer layer of tape wrap has a thickness that is as great as the inner layer of tape wrap.

7. The insulating system as in claim 1; wherein, the C-shaped polyurethane shells are joined together by a mechanical connection.

8. The insulating system as in claim 1; wherein, the C-shaped polyurethane half shells are joined together by a chemical bond.

9. The insulating system as in claim 1; wherein, the polyurethane half shells are joined together by both a mechanical connection and a chemical bond.

10. The insulating system as in claim 3; wherein, the C-shaped polyurethane shells are joined together by a mechanical connection.

11. The insulating system as in claim 3; wherein, the C-shaped polyurethane half shells are joined together by a chemical bond.

12. The insulating system as in claim 3; wherein, the polyurethane half shells are joined together by both a mechanical connection and a chemical bond.

13. The insulating system as in claim 1 further comprising
a layer of mastic disposed intermediate the outer layer of tape wrap and the exterior of said polyurethane half shells.

14. The insulating system as in claim 3 further comprising
a layer of mastic disposed intermediate the outer layer of tape wrap and the exterior of said polyurethane half shells.

15. The insulating system as in claim 3 further comprising
a layer of mastic disposed intermediate the outer layer of tape wrap and the exterior of said polyurethane half shells.

16. A method of insulating the exterior surface of steel pipes comprising the steps of
a) applying an inner layer of tape wrap along the entire length of steel pipe
b) joining two polyurethane half shells together in a surrounding relationship relative to said inner layer of tape wrap
c) applying an outer layer of tape wrap around the joined polyurethane half shells.

17. The method as in claim 16 further comprising a preliminary step prior to step a):
d) applying a primary coating of a selected one of the following materials: epoxy, polyurethane, FBE to the exterior surface of said steel pipe.

18. The method as in claim 16 further comprising an intermediate step between steps a) and b)
e) coating the abuttable surfaces of he polyurethane half shells with a chemical bonding agent.

19. The method as in claim 17 further comprising an intermediate step between steps a) and b)
e) coating the abuttable surfaces of he polyurethane half shells with a chemical bonding agent.

20. The method as in claim 16 further comprising an intermediate step between steps b) and c)
f) applying a layer of mastic on the exterior surfaces of the polyurethane half shells.
